(19) United States
(12) Patent Application Publication
(10) Pub. No.: US 2004/0027976 A1
(43) Pub. Date: Feb. 12, 2004

(54) Braking methods of an optical head in an optical disk system

(76) Inventor: Katsuhiko Shinohara, Kakogawa-shi (JP)

Correspondence Address: Katsuhiko Shinohara, 669-20, Kimura, Kakogawa-choo, Kakogawa-Shi, 675-0038, JP

(21) Appl. No.: 10/315,258

(22) Filed: Dec. 10, 2002

(30) Foreign Application Priority Data
Aug. 12, 2002 (JP) 2002-287526

(51) Int. Cl. G11B 17/30; G11B 21/02; G11B 17/00; G11B 21/16

(52) U.S. Cl. 369/220; 369/251

(57) ABSTRACT

The remaining vibrations of the main unit of an optical carriage are detected though the tracking signals, and then piezoelectric devices in the said optical carriage are pressed against the braking bars penetrating through it, only for a very short time, at the moment at the centre of the waveforms produced by the tracking signals.

### FIELD OF THE INVENTION

This invention relates to the braking methods of an optical head in an optical disk system, shortening the amount of time required to convert from the macro-seeking to micro-seeking modes.

### BACKGROUND OF THE INVENTION

When a conventional optical head is actuated towards a desired location for tracking, it is first moved by a coarse actuator, which is poorly respondent but greatly movable and then by a fine actuator which is rapidly respondent but less movable.

Therefore, when the said optical head is strongly actuated during macro-seeking, the total seeking time can only be shortened a little due to the lingering vibrations, as such, it takes quite while for macro-seeking to convert into a micro-seeking mode.

### SUMMARY OF THE INVENTION

The object of the present invention is to provide a method to reduce the total seeking time of the said optical head by decreasing the remaining vibrations of an optical carriage at the end of the macro-seeking process.

In order to achieve these objectives, using braking methods for the said optical head in an optical disk system in the present invention, the remaining vibrations of the said optical carriage are detected via tracking signals and the brakes of the said optical carriage are pressed against a braking bar for only an extremely short period of time at the centre of oscillation in the remaining vibration forms.

Consequently, the remaining vibrations of the said optical carriage can be reduced in a shorter time than previously possible, and the micro-seeking process can start immediately by means of a galvanometer mirror, thus achieving a reduction in the total seeking time required.

### BRIEF DESCRIPTION OF THE DRAWINGS

FIG. 1 is a side view of an optical carriage.

### DESCRIPTION OF THE PREFERRED EMBODIMENTS

An embodiment of the present invention is explained hereinafter referring to Figures.

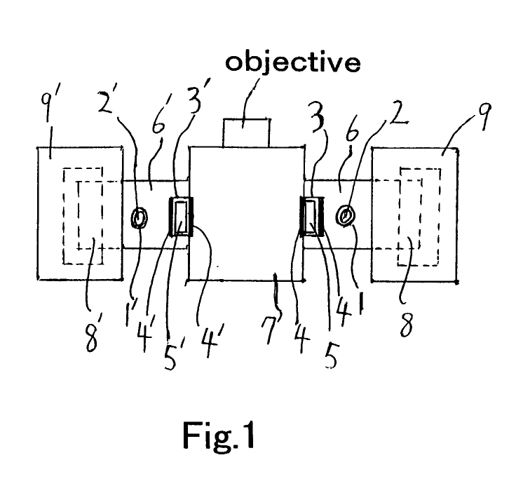

In FIG. 1, tunnels 1,1′ penetrated with respective guide rails 2,2′ and tunnels 3,3′ having respective piezoelectric devices 4,4′ on their walls penetrated with respective braking bars 5,5′ are installed on both of the two respective coupling-wings 6,6′ which join the main unit of an optical carriage 7 to coils 8,8′ in magnet yokes 9,9′.

The centroid of the main unit of the said optical carriage 7 exists on the plain which includes the said two tunnels 3,3′.

In order to stop the remaining vibrations of the said optical carriage 7, the said piezoelectric devices 4,4′ are pressed against the said respective braking bars 5,5′ only for a very short time, at the moment of the centre of oscillation in the remaining vibrations of the said optical carriage 7 detected through the tracking signals of an optical disk.

The said piezoelectric devices 4,4′ are vibrated a few times, and give mechanical friction created by the contact between these and the said braking bars 5,5′, resulting in shortening a total seeking time of the said optical disk.

There is an embodiment where brakes on the walls in respective tunnels are pressed against the braking bars penetrating them, for a very short time via electromagnetic force.

In the braking methods of an optical head in an optical disk system in this invention, the remaining vibrations of the main unit of the said optical carriage 7 are detected through the tracking signals, and then the said piezoelectric devices 4,4′ in the said optical carriage 7 are pressed against the said respective braking bars 5, 5′ only for a very short time at the moment of the center of oscillation in the remaining vibrations of the said optical carriage 7, or at the moment of the least distortion between the main unit of the said optical carriage 7 and the said coils 8,8′.

Therefore, there is an effect that the said remaining vibrations of the main unit of the said optical carriage 7 are removed efficiently and that the micro-seeking process can be started immediately.

There is an effect that the remaining vibrations of the said optical carriage 7 are at a minimum after the braking operation, because the centroid of the main unit of the said optical carriage 7 exists on the plain which includes the said two tunnels 3,3′.

There is an effect that the micro-seeking process can start immediately following the macro-seeking process, because the said piezoelectric devices 4,4′ are pressed against the said respective braking bars 5,5′ only for a very short time.

While a few embodiments of the invention have been illustrated and described in detail, it is particularly understood that the invention is not limited thereto or thereby.

What is claimed is:

1. Braking methods for an optical head in an optical disk system comprising: braking an optical head through mechanical friction at the end of macro-seeking process.

2. Braking methods according to claim 1, wherein said mechanical friction is applied for only for a very short time at the moment of the centre of oscillation in the remaining vibrations of the optical carriage at the end of macro-seeking process.

3. Braking methods according to claim 2, wherein piezoelectric devices are adopted for applying said mechanical friction.
